(19) United States
(12) Patent Application Publication
(10) Pub. No.: US 2014/0176628 A1
(43) Pub. Date: Jun. 26, 2014

(54) CONTROL EJECTION OF INK DROPS TO RESPECTIVE REGIONS IN THE SPITTOON

(71) Applicant: HEWLETT-PACKARD DEVELOPMENT COMPANY, L.P., Houston, TX (US)

(72) Inventors: Jeffrey Jay Anderson, Pittsburgh, PA (US); Stuart Scofield, Battle Ground, WA (US)

(73) Assignee: Hewlett-Packard Development Company, L.P., Houston, TX (US)

(21) Appl. No.: 13/723,348

(22) Filed: Dec. 21, 2012

(51) Int. Cl. B41J 2/165

(52) U.S. Cl. CPC B41J 2/1652
USPC 347/12

(57) ABSTRACT

A method of maintaining nozzles of a printhead includes periodically moving a printhead having a plurality of nozzles toward a spittoon, and ejecting a plurality of sets of ink drops from the nozzles of the printhead to the spittoon mode. The method also includes controlling the ejecting of the plurality of sets of ink drops from the nozzles of the printhead to the spittoon by the control module. Consecutive sets of ink drops received by the spittoon are received by different sets of regions of the plurality of sets of regions within the spittoon.

### BACKGROUND

Printing systems such as inkjet printers may include a print mode and a maintenance mode. An inkjet printer may include a printhead having nozzles to eject ink drops therefrom. In the print mode, the printhead may eject ink drops from the nozzles to a substrate to form images thereon. In the maintenance mode, the printhead may eject ink drops from respective nozzles into a spittoon to refresh the respective nozzles.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram illustrating a printing system according to an example.

FIG. 2 is a perspective view illustrating the printing system of FIG. 1 according to an example.

FIG. 3 is a top view illustrating a spittoon of the printing system of FIG. 2 according to an example.

FIGS. 4A and 4B are schematic views illustrating a printhead ejecting respective sets of ink drops to a spittoon of the printing system of FIG. 2 according to examples.

FIG. 4C is a side view illustrating a respective region of a spittoon of the printing system of FIG. 2 having a plurality of ink drops deposited thereon according to an example.

FIG. 5 is a perspective view illustrating the printing system of FIG. 2 according to an example.

FIG. 6 is a flowchart illustrating a method of maintaining nozzles of a printhead of a printing system according to an example.

FIG. 7 is a block diagram illustrating a computing device such as a printing system including a processor and a non-transitory, computer-readable storage medium to store instructions to operate the printing system according to an example.

### DETAILED DESCRIPTION

Printing systems such as inkjet printers may include a print mode and a maintenance mode. An inkjet printer may include a printhead having nozzles to eject ink drops therefrom. In the print mode, the printhead may eject ink drops from the nozzles to a substrate to form images thereon. In the maintenance mode, the printhead may eject ink drops from respective nozzles into a spittoon to refresh the respective nozzles. The ink drops ejected from and to refresh the nozzles in the maintenance mode may be referred to as service spits. Such service spits may be ejected at an end of a print job such as prior to capping the printhead, at a beginning of a print job such as after uncapping of the printhead, and/or during a print job, and the like. Generally, the service spats are received in a same area of the spittoon which may cause ink buildup in the form of a stalagmite. Additionally, the spittoon may be positioned proximate to the printhead when receiving ink drops therefrom to reduce aerosol formation, but in doing so, potentially decrease the life of the spittoon. Consequently, the stalagmite growth may decrease spittoon life, cause undesirable contact with the printhead, and the like.

In examples, a method of maintaining nozzles of a printhead may include periodically moving a printhead having a plurality of nozzles toward a spittoon, and ejecting a plurality of sets of ink drops from the nozzles of the printhead to the spittoon. The method may also include identifying a plurality of sets of regions spaced apart from each other within the spittoon to receive respective sets of ink drops ejected from the printhead. The method may also include controlling the ejecting of the plurality of sets of ink drops from the nozzles of the printhead to the spittoon by the control module. For example, consecutive sets of ink drops received by the spittoon are received by different sets of regions of the plurality of sets of regions within the spittoon. Thus, the spittoon may be used in a more efficient manner and the rate of stalagmite growth may be reduced. Further, such efficient spittoon use may warrant a smaller-size spittoon to allow space saving in the printing system. Additionally, due the increased efficient use of the spittoon, the spittoon may be positioned proximate to the printhead when receiving ink drops therefrom to reduce aerosol while potentially reducing a decrease to the life of the spittoon.

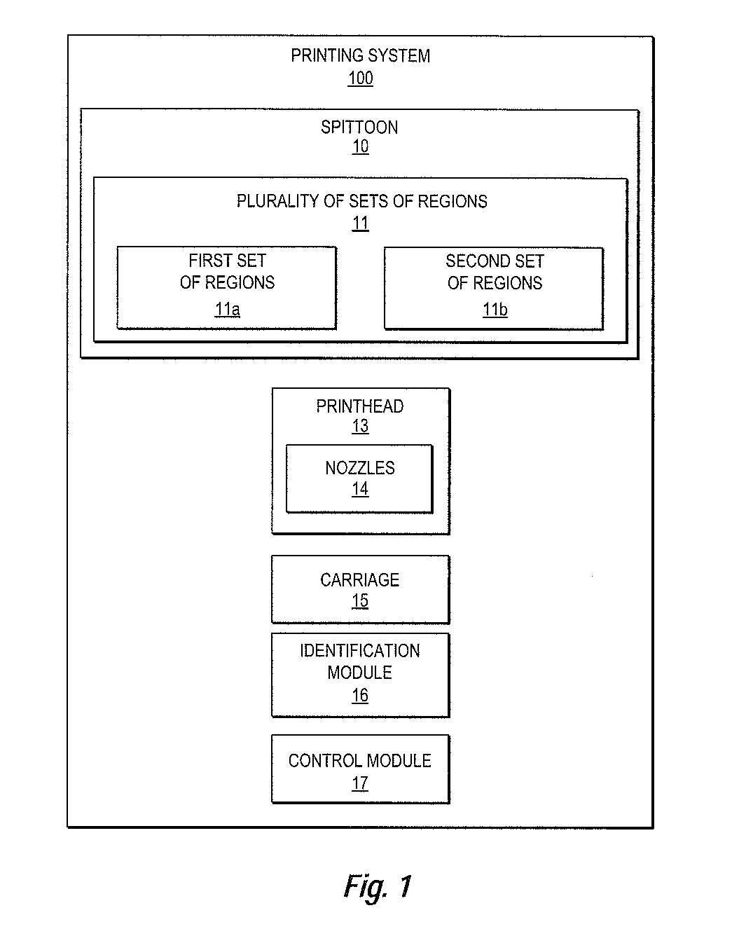

FIG. 1 is a block diagram illustrating a printing system according to an example. The printing system 100 may have a maintenance mode and a print mode. Referring to FIG. 1, in some examples, a printing system 100 may include a spittoon 10, a printhead 13, a carriage 15, an identification module 16, and a control module 17. The printhead 13 may include a plurality of nozzles 14. The printhead 13 may eject ink drops from the nozzles 14 to the spittoon 10 in the maintenance mode and to a substrate in the print mode. In some examples, the printhead 13 may include a plurality of printhead modules, an integrated multicolor printhead, a printhead assembly, and the like.

Referring to FIG. 1, in some examples, the carriage 15 may be coupled to the printhead 13. The carriage 15 may move the printhead 13 toward the spittoon 10 in the maintenance mode and in a print zone in the print mode. The identification module 16 may identify a plurality of sets of regions 11 including a first set of regions 11a and a second set of regions 11b within the spittoon 10 to receive respective sets of ink drops ejected from the printhead 13 in the maintenance mode. Each set of regions 11a and 11b may include a plurality of regions. The control module 17 may control an order in which the ink drops ejected from the printhead 13 in the maintenance mode are received at the plurality of sets of regions 11 within the spittoon 10.

In some examples, an identification module 16 and/or a control module 17 may be implemented in hardware, software including firmware, or combinations thereof. The firmware, for example, may be stored in memory and executed by a suitable instruction-execution system. If implemented in hardware, as in an alternative example, the identification module 16 and/or the control module 17 may be implemented with any or a combination of technologies which are well known in the art (for example, discrete-logic circuits, application-specific integrated circuits (ASICs), programmable-gate arrays (PGAs), field-programmable gate arrays (FPGAs), and/or other later developed technologies. In other examples, the identification module 16 and/or the control module 17 may be implemented in a combination of software and data executed and stored under the control of a computing device.

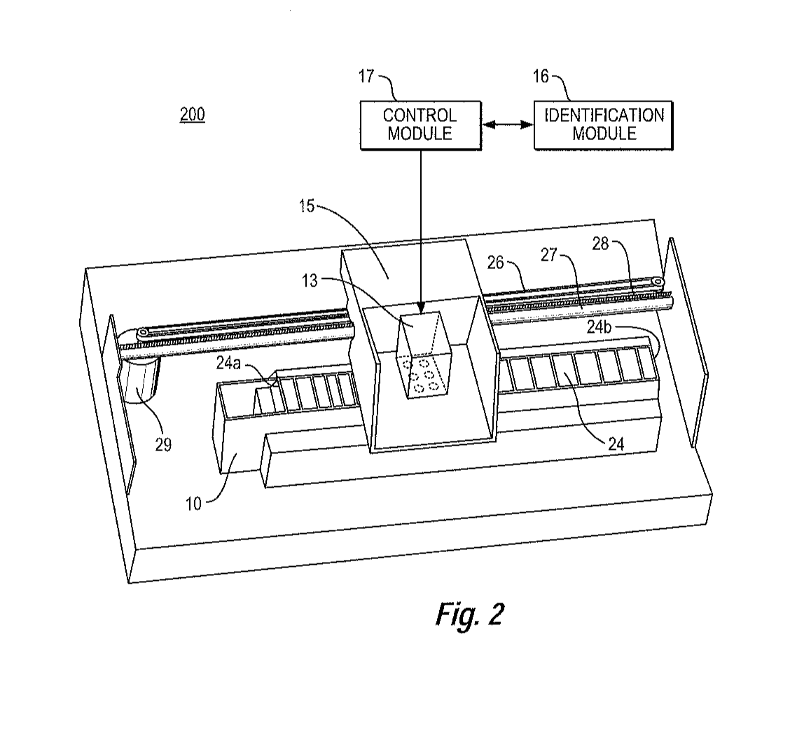

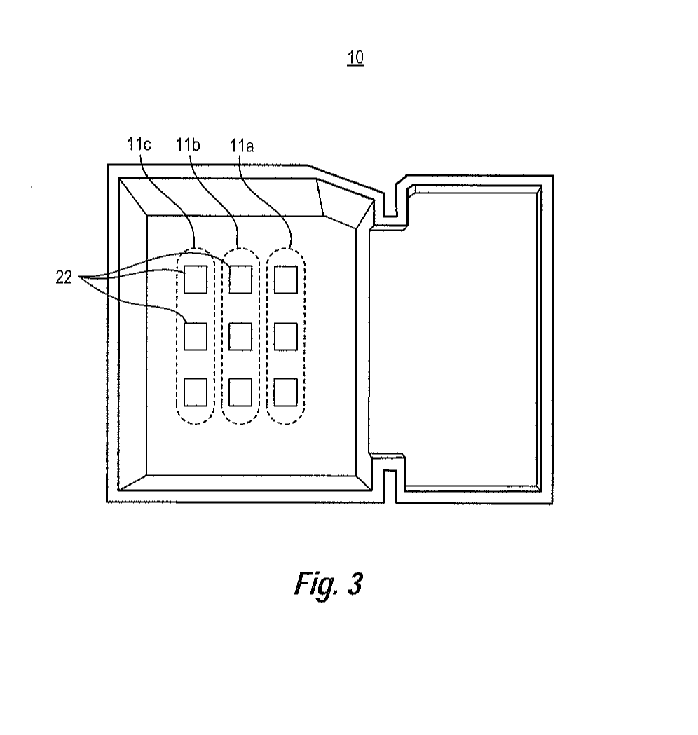

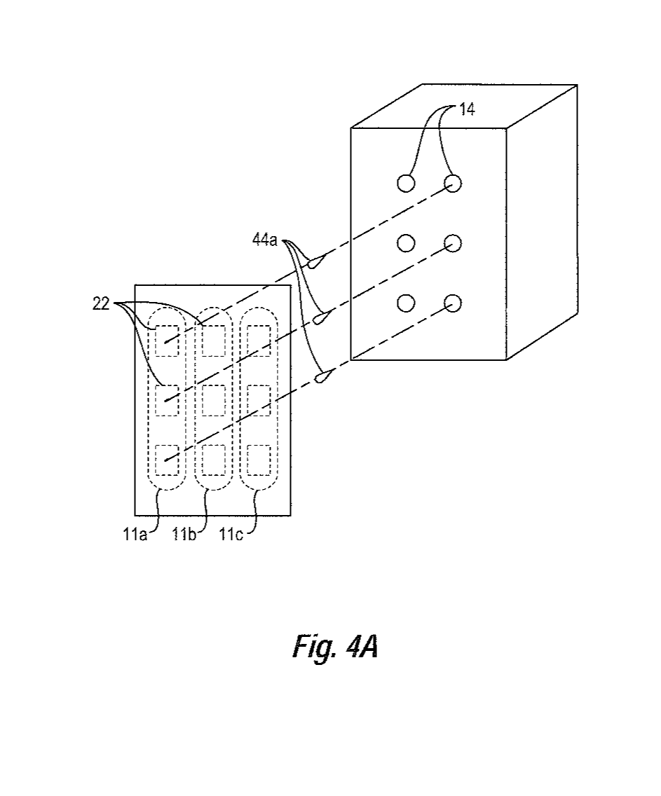

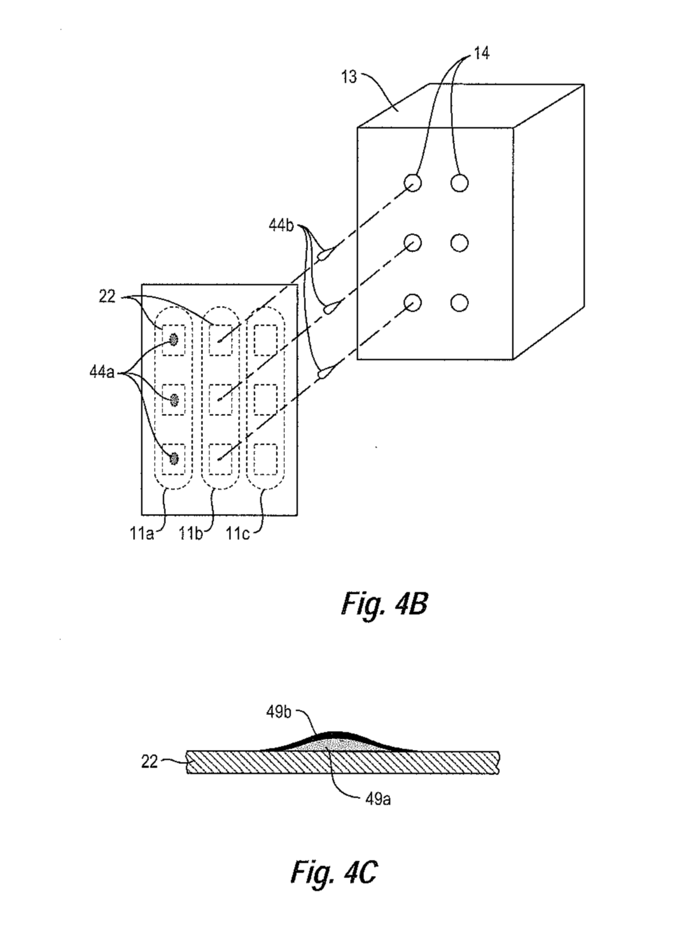

FIG. 2 is a perspective view illustrating the printing system of FIG. 1 according to an example. FIG. 3 is a top view illustrating a spittoon of the printing system of FIG. 2 according to an example. FIGS. 4A and 4B are schematic views illustrating a printhead ejecting respective sets of ink drops to a spittoon of the printing system of FIG. 2 according to examples. FIG. 4C is a side view illustrating a respective region of a spittoon of the printing system of FIG. 2 having a plurality of ink drops deposited thereon according to an example. Referring to FIGS. 2-4C, in some examples, a printing system 200 may include the spittoon 10, the printhead 13, the carriage 15, the identification module 16, and the control module 17 as previously described with respect to FIG. 1.

Referring to FIGS. 2-4C, in some examples, the printing system 200 may also include a platen 24 and a carriage transport assembly. The carriage transport assembly may include a carriage motor 29, a carriage belt 26, a carriage rod 27, and a carriage encoder 28. The platen 24 may receive a substrate and include a first end 24a and a second end 24b. The spittoon 10 may be located by the first end 24a of the platen 24. The carriage motor 29 may drive the carriage belt 26 to move the carriage 15 along a carriage rod 27 and across from a carriage encoder 28. The position of the carriage 15 may be determined based on its position with respect to the carriage encoder 28. In some examples, the carriage 15 may move the printhead 13 across the platen 24 toward and away from the spittoon 10. The printhead 13 may eject ink drops into the spittoon 10 in the maintenance mode when periodically placed across therefrom.

In some examples, the printhead 13 may be selectively moved into a print zone during the print mode and across from the spittoon 10 in a maintenance mode. For example, in the print mode, the printhead 13 may eject ink drops to form an image on a substrate located on the platen 24 in the print zone. Alternatively, in the maintenance mode, the printhead 13 may be placed across from and eject ink drops into the spittoon 10. That is, in the maintenance mode, the printhead 13 may selectively eject respective sets of ink drops from a corresponding set of nozzles into the spittoon 10.

For example, a first set of ink drops 44a may be formed by simultaneously ejecting ink drops corresponding to a first column of nozzles of the printhead 13. The first set of ink drops 44a, for example, may correspond to black ink. In some examples, the first set of ink drops 44a may be formed of a first type of ink 49a such as pigment-based ink. A second set of ink drops 44b may be formed by simultaneously ejecting ink drops corresponding to a second column of nozzles of the printhead 13. Alternatively, the second set of ink drops 44b may be formed by simultaneously ejecting ink drops from the first set of nozzles at a subsequent time than the formation of the first set of ink drops 44a therefrom. In some examples, the second set of ink drops 44b may be formed of a second type of ink such as dye-based ink.

In some examples, the spittoon 10 may include a plurality of sets of regions including a first set of regions 11a, a second set of regions 11b, and a third set of regions 110 (collectively 21) to receive the respective sets of ink drops 44a and 44b ejected from the printhead 13 in the maintenance mode as illustrated in FIG. 3. Each set of regions 11a, 11b, and 11c may include a plurality of regions 22. Each one of the respective sets of regions 11a, 11b, and 11c may be spaced apart from each other. In some examples, the spittoon 10 may include ten sets of regions and adjacent sets of regions may be spaced apart from each other by a distance of approximately 0.5 millimeters.

In some examples, the identification module 16 may identify the plurality of sets of regions within the spittoon 10 to receive respective sets of ink drops 44a and 44b ejected from the printhead 13 in the maintenance mode. For example, the identification module 16 may include and/or access a lookup table including predetermined locations of each one of the respective sets of regions 21 and corresponding regions 22 thereof. In some examples, the control module 17 may communicate with the identification module 16 to obtain the identified plurality of sets of regions 21 within the spittoon 10. In some examples, the control module 17 may include the identification module 16. The control module 17 may control an order in which the ink drops ejected from the printhead 13 in the maintenance mode are received at the plurality of sets of regions 21 within the spittoon 10. In some examples, the control module 17 may be a processor.

The control module 17 may control an order in which the ink drops ejected from the printhead 13 in the maintenance mode are received at the plurality of sets of regions 21 within the spittoon 10. For example, the order may correspond to different sets of regions within the spittoon 10 to receive consecutive sets of ink drops 44a and 44b ejected from the printhead 13 in the maintenance mode. In some examples, the order may correspond to each set of the plurality of sets of regions 21 within the spittoon 10 to sequentially receive a consecutive set of ink drops 44a and 44b ejected from the printhead 13 in the maintenance mode. Alternatively, the order may correspond to each set of the plurality of sets of regions 21 within the spittoon 10 to receive a set of non-consecutive ink drops ejected from the printhead 13 in the maintenance mode. Additionally, an order in which each one of the plurality of sets of regions 21 within the spittoon 10 sequentially receive the respective set of ink drops may be repeated for subsequent sets of ink drops ejected from the printhead 13 in the maintenance mode.

In some examples, for each one of a respective region 22 within the spittoon 10, ink drops of a first type of ink 49a and a second type of ink 49b ejected by the printhead 13 are received in an alternating manner as illustrated in FIG. 4C. For example, the first type of ink 49a may include a pigment-based ink and the second type of ink may include a dye-based ink. In some examples, dye-based ink may contact the pigment-based ink deposited on a respective region 22 of the spittoon 10 to cause the pigment-based ink to spread on the respective region 22. Accordingly, a respective height of a stalagmite formed on the respective region 22 of the spittoon 10 may be reduced.

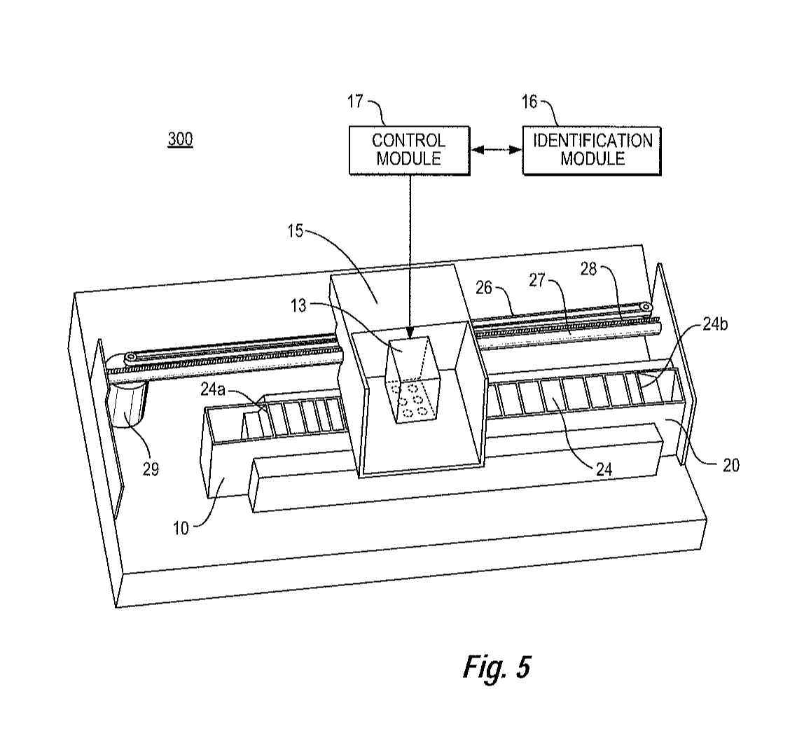

FIG. 5 is a perspective view illustrating the printing system of FIG. 2 according to an example. The printing system 300 may include the spittoon 10, the printhead 13, the carriage 15, the identification module 16, the control module 17, the platen 24, the carriage motor 29, the carriage belt 26, the carriage rod 27, and the carriage encoder 28 as previously described with respect to FIGS. 2-4C. Referring to FIG. 5, in some examples, the printing system 300 may also include a second spittoon 20 located at the second end 24b of the platen 24. For example, the carriage 15 may move the printhead 13 back and forth across the platen 24 between the spittoon 10 and the second spittoon 20, respectively. The printhead 13 may eject ink drops into the respective spittoon 10 and 20 in the maintenance mode when placed across therefrom. In some examples, the second spittoon 20 may include a plurality of sets of regions 21 to selectively receive sets of ink drops 44a and 44b as described with respect to the spittoon 10. Alternatively, unlike the spittoon 10, the second spittoon 20 may receive ink substantially in a same area. For example, the second spittoon 20 my receive ink drops formed of dye-based less conducive to the formation of stalagmites than pigment-based ink.

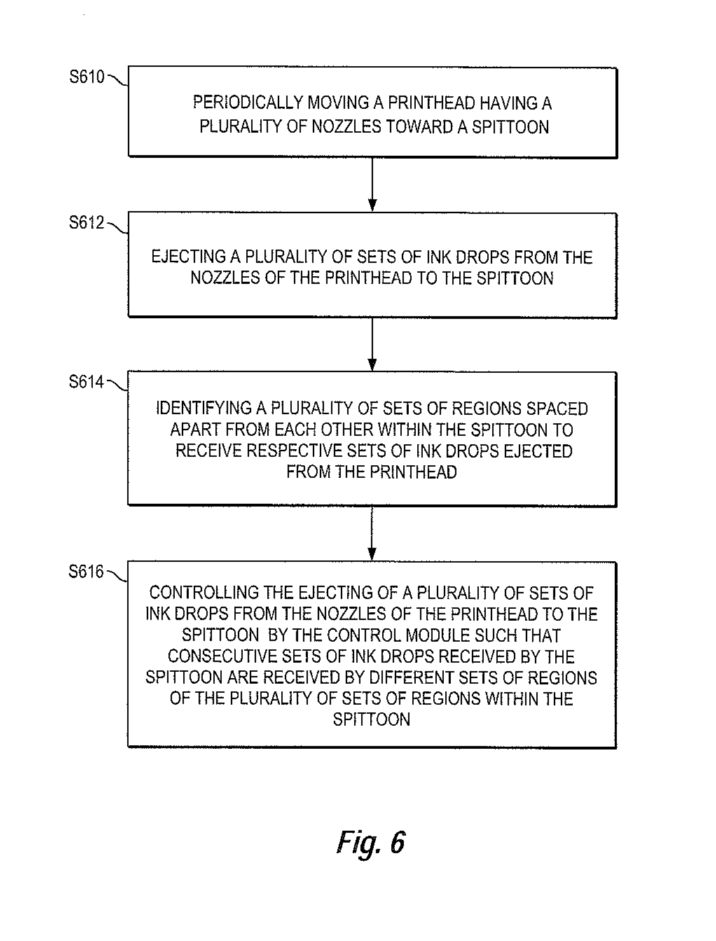

FIG. 6 is a flowchart illustrating a method of maintaining nozzles of a printhead of a printing system according to an example. Referring to FIG. 6, in block S610, a printhead having a plurality of nozzles is periodically moved toward a spittoon. For example, a carriage coupled to the printhead may be periodically moved to a first position located across from the spittoon. In some examples, a carriage coupled to the printhead may be periodically moved between a first position located across from the spittoon and a second position located across from a second spittoon. In block S612, a plurality of sets of ink drops is ejected from the nozzles of the printhead to the spittoon. In block S614, a plurality of sets of regions spaced apart from each other is identified within the spittoon to receive respective sets of ink drops ejected from the printhead.

In block S616, the ejecting of the plurality of sets of ink drops from the nozzles of the printhead to the spittoon is controlled by the control module such that consecutive sets of ink drops received by the spittoon are received by different sets of regions of the plurality of sets of regions within the spittoon. In some examples, a respective set of ink drops ejected from the printhead in the maintenance mode may be sequentially received by each one of the plurality of sets of regions within the spittoon. Additionally, an order in which each one of the plurality of sets of regions within the spittoon sequentially receive the respective set of ink drops may be repeated for subsequent sets of ink drops ejected from the printhead.

In some examples, for each one of a respective region within the spittoon, ink drops of a first type of ink and a second type of ink ejected by the printhead are received in an alternating manner. For example, the first type of ink may include a pigment-based ink and the second type of ink may include a dye-based ink. In some examples, each one of the plurality of sets of ink drops from the nozzles of the printhead is ejected in an alternating manner to the spittoon and the second spittoon, respectively.

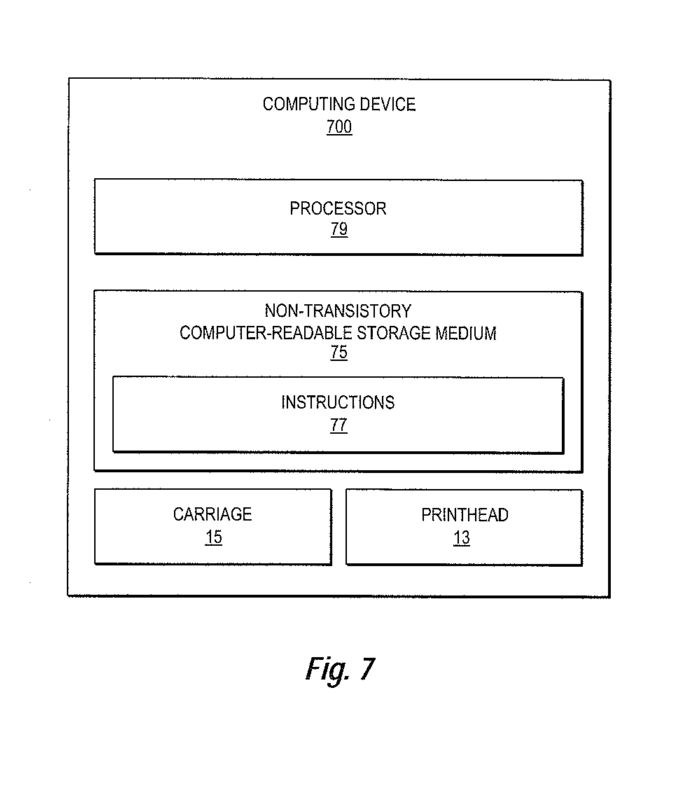

FIG. 7 is a block diagram illustrating a computing device such as a printing system including a processor and a non-transitory, computer-readable storage medium to store instructions to operate the printing system according to an example. Referring to FIG. 7, in some examples, the non-transitory, computer-readable storage medium 75 may be included in a computing device 700 such as a printing system including a carriage 15 and a printhead 13. In some examples, the non-transitory, computer-readable storage medium 75 may be implemented in whole or in part as instructions 77 such as computer-implemented instructions stored in the computing device locally or remotely, for example, in a server or a host computing device which may be considered herein to be part of the printing system.

Referring to FIG. 7, in some examples, the non-transitory, computer-readable storage medium 75 may correspond to a storage device that stores instructions 77, such as computer-implemented instructions and/or programming code, and the like. For example, the non-transitory, computer-readable storage medium 75 may include a non-volatile memory, a volatile memory, and/or a storage device. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM).

Referring to FIG. 7, examples of storage devices include, but are not limited to, hard disk drives, compact disc drives, digital versatile disc drives, optical drives, and flash memory devices. In some examples, the non-transitory, computer-readable storage medium 75 may even be paper or another suitable medium upon which the instructions 77 are printed, as the instructions 77 can be electronically captured, via, for instance, optical scanning of the paper or other medium, then compiled, interpreted or otherwise processed in a single manner, if necessary, and then stored therein. A processor 79 generally retrieves and executes the instructions 77 stored in the non-transitory, computer-readable storage medium 75, for example, to operate a computing device 700 such as the printing system in accordance with an example. In an example, the non-transitory, computer-readable storage medium 75 can be accessed by the processor 79.

It is to be understood that the flowchart of FIG. 6 illustrates architecture, functionality, and/or operation of examples of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 6 illustrates a specific order of execution, the order of execution may differ from that which is depicted. For example, the order of execution of two or more blocks may be rearranged relative to the order illustrated. Also, two or more blocks illustrated in succession in FIG. 6 may be executed concurrently or with partial concurrence. All such variations are within the scope of the present disclosure.

The present disclosure has been described using non-limiting detailed descriptions of examples thereof that are not intended to limit the scope of the general inventive concept. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the general inventive concept and which are described for illustrative purposes. Structure and acts described herein are replaceable by equivalents, which perform the same function, even if the structure or acts are different, as known in the art. Therefore, the scope of the general inventive concept is limited only by the elements and limitations as used in the claims.

What is claimed is:

1. A method of maintaining nozzles of a printhead of a printing system, the method comprising:
periodically moving a printhead having a plurality of nozzles toward a spittoon;
ejecting a plurality of sets of ink drops from the nozzles of the printhead to the spittoon;
identifying a plurality of sets of regions spaced apart from each other within the spittoon to receive respective sets of ink drops ejected from the printhead; and
controlling the ejecting of the plurality of sets of ink drops from the nozzles of the printhead to the spittoon by the control module such that consecutive sets of ink drops received by the spittoon are received by different sets of regions of the plurality of sets of regions within the spittoon.

2. The method according to claim 1, wherein the controlling the ejecting of the plurality of sets of ink drops from the nozzles of the printhead to the spittoon by the control module further comprises:
sequentially receiving a respective set of ink drops ejected from the printhead by each one of the plurality of sets of regions within the spittoon.

3. The method according to claim 2, wherein the sequentially receiving a respective set of ink drops ejected from the printhead by each one of the plurality of sets of regions within the spittoon further comprises:
repeating an order in which each one of the plurality of sets of regions within the spittoon sequentially receive the respective set of ink drops for subsequent sets of ink drops ejected from the printhead.

4. The method according to claim 1, wherein the periodically moving a printhead having a plurality of nozzles toward a spittoon further comprises:
periodically moving a carriage coupled to the printhead to a first position located across from the spittoon.

5. The method according to claim 1, wherein the periodically moving a printhead having a plurality of nozzles toward a spittoon further comprises:
periodically moving a carriage coupled to the printhead between a first position located across from the spittoon and a second position located across from a second spittoon.

6. The method according to claim 5, wherein the controlling the ejecting of the plurality of sets of ink drops from the nozzles of the printhead to the spittoon by the control module further comprises:
ejecting each one of the plurality of sets of ink drops from the nozzles of the printhead in an alternating manner to the spittoon and the second spittoon, respectively.

7. The method according to claim 1, wherein for each one of a respective region within the spittoon, ink drops of a first type of ink and a second type of ink ejected by the printhead are received in an alternating manner.

8. The method according to claim 1, wherein the first type of ink includes a pigment-based ink and the second type of ink includes a dye-based ink.

9. A printing system having a maintenance mode and a print mode, the printing system comprising:
a spittoon;
a printhead having a plurality of nozzles, the printhead to eject ink drops from the nozzles to the spittoon in the maintenance mode and to a substrate in the print mode;
a carriage coupled to the printhead, the carriage to move the printhead toward the spittoon in the maintenance mode and in a print zone in the print mode;
an identification module to identify a plurality of sets of regions within the spittoon to receive respective sets of ink drops ejected from the printhead in the maintenance mode, each set of regions including a plurality of regions; and
a control module to control an order in which the ink drops ejected from the printhead in the maintenance mode are received at the plurality of sets of regions within the spittoon.

10. The printing system according to claim 9, wherein the order corresponds to different sets of regions within the spittoon to receive consecutive sets of ink drops ejected from the printhead in the maintenance mode.

11. The printing system according to claim 9, wherein the order corresponds to each set of the plurality of sets of regions within the spittoon to sequentially receive a consecutive set of ink drops ejected from the printhead in the maintenance mode.

12. The printing system according to claim 9, wherein the order corresponds to each set of the plurality of sets of regions within the spittoon to receive a set of non-consecutive ink drops ejected from the printhead in the maintenance mode.

13. The printing system according to claim 9, further comprising:
a platen to receive the substrate, the platen having a first end and a second end;
a second spittoon located by the second end of the platen; and
wherein the spittoon is located by the first end of the platen.

14. The printing system according to claim 9, wherein the printhead ejects ink drops of a first type of ink and a second type of ink such that, for each respective region in the spittoon, the ink drops of the first type of ink and the second type of ink are received in an alternating manner.

15. A non-transitory computer-readable storage medium having computer executable instructions stored thereon to operate a printing system, the instructions are executable by a processor to:
direct a carriage coupled to a printhead having a plurality of nozzles to periodically move toward a spittoon in a maintenance mode;
direct the printhead to eject a plurality of sets of ink drops from the nozzles thereof to the spittoon in the a maintenance mode; and
control the ejecting of the plurality of sets of ink drops from the nozzles of the printhead to the spittoon in the maintenance mode such that consecutive sets of ink drops received by the spittoon are received by different sets of regions of a plurality of sets of regions spaced apart from each other within the spittoon.
